(19) United States
(12) Patent Application Publication
(10) Pub. No.: US 2006/0046538 A1
(43) Pub. Date: Mar. 2, 2006

(54) Microphone and microphone shield

(75) Inventor: Hiroshi Akino, Machida-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Audio-Technica, Machida-shi (JP)

(21) Appl. No.: 11/195,765

(22) Filed: Aug. 3, 2005

(30) Foreign Application Priority Data
Aug. 31, 2004 (JP) 2004-252183

(51) Int. Cl. H01R 13/648

(52) U.S. Cl. 439/101

(57) ABSTRACT

A microphone comprises a microphone connector receiving a cable connector provided at one end of a microphone cable, connecting the microphone cable and an inner circuit of the microphone and including grounding and signaling pins; a microphone case housing the microphone connector; and a metal shield fitted into the microphone connector, and having a plurality of projections on a peripheral edge thereof and a plurality of openings into which the pins pass through, the projections of the metal shield being in pressure contact with an inner surface of the microphone connector and electrically connected to the microphone case, the opening for the grounding pin having projections extending on an inner surface thereof, being in pressure contact with the grounding pin, and being electrically connected to the metal shield.

### CROSS REFERENCE TO RELATED APPLICATIONS

This invention is based upon and claims the benefit of priority from prior Japanese Patent Application No. 2004-252183 filed on Aug. 31, 2004; the entire contents of which are incorporated herein.

### BACKGROUND OF THE INVENTION

1. Field of the Invention

The present invention relates to a microphone and a microphone shield, and more particularly to a structure of a connector connecting a dedicated microphone cable to a capacitor microphone, and a shield therefor.

2. Description of the Related Art

A capacitor microphone usually has high impedance in a microphone unit, and includes an impedance converter constituted by a field effect transistor (FET), which converts the high impedance into a low impedance. An audio signal converted by the microphone is output via a balanced and shielded cable connected to the microphone.

When strong electromagnetic waves get into an output cable of the microphone, a high frequency current runs through the output cable, gets into the microphone via a microphone connector. Especially, with a capacitor microphone, the high frequency current is demodulated by an impedance converter, and is mixed into a microphone output as noise.

At present, as cellular phones are very popular, high frequency electromagnetic waves spread anywhere, and gets into a microphone cable or a connector thereof. Hence, noise tends to be mixed into audio signals. Especially, a capacitor microphone is very susceptible to high frequency signals from nearby cellular phones, so that such high frequency signals cause noise.

Generally speaking, a microphone cable is attached to and detached from a microphone using a 3-pin microphone connector (e.g., according to EIAJ RC-5236, “Circular connectors, latch lock type for audio equipment”). With the microphone connector, No.1 pin is used grounding, and No. 2 pin and No. 3 pin are used as a hot side and a cold side of a signal. Referring to FIG. 5(A) of the accompanying drawings, No. 1 pin is connected to a microphone case 10 and to a connecting terminal of a signal circuit 12 via a conductor 14, thereby shielding the microphone against external electromagnetic waves.

However, the conductor 14, which connects No. 1 pin and the microphone case 10 and connects No. 1 pin and the connecting terminal of the signal circuit 12, functions as an antenna or serves as a common impedance, so that a high frequency current flows through the conductor 14. Hence, noise is mixed into the audio signal. Usually, the conductor 14 is housed in the microphone case, and is a long electric wire. In such a case, a high frequency current is induced into an electronic circuit in the microphone case 10, causing noise.

If the presence of the conductor 14 is not preferable in view of noise prevention, it is conceivable to not to use the conductor 14, and to directly connect No. 1 pin and the microphone case 10 as shown in FIG. 5(B). Such a structure is effective in preventing noise. However, there is the following problem when no conductor 14 is used to connect No. 1 pin and a connecting terminal of the signal circuit 12 in the capacitor microphone. In other word, a relatively high pressure is applied to a diaphragm in order to maintain electric charges thereon. However, if a voltage maintaining electric charges leaks into the microphone case 10, a person using the microphone will be electrified. Usually, such a voltage is not large enough to be harmful to the user. However, if affected by the voltage all of a sudden, the user may feel unpleasant.

There have been proposals to protect the microphone body using a shield (as described in Japanese Patent Laid-Open Publications No. 2002-152,892 and No. Hei 11-155,198, for example). Even if the microphone is totally covered by a shield case, it is not always possible to prevent noise caused by electromagnetic waves from being mixed into audio signals.

### SUMMARY OF THE INVENTION

According to a first aspect of the invention, there is provided a microphone comprising a microphone connector receiving a cable connector provided at one end of a microphone cable, connecting the microphone cable and an inner circuit of the microphone and including grounding and signaling pins; a microphone case housing the microphone connector; and a metal shield fitted into the microphone connector, and having a plurality of projections on a peripheral edge thereof and a plurality of openings into which the grounding and signaling pins pass through, the projections of the metal shield being in pressure contact with an inner surface of the microphone connector and electrically connected to the microphone case, the opening for the grounding pin having projections extending on an inner surface thereof, being in pressure contact with the grounding pin, and being electrically connected to the metal shield.

In accordance with a second aspect of the invention, there is provided a microphone shield for a microphone which comprises a microphone connector receiving a cable connector provided at one end of a microphone cable, connecting the microphone cable and an inner circuit of the microphone and including grounding and signaling pins, and a microphone case housing the microphone connector. The microphone shield comprises a metal shield fitted into the microphone connector, and has a plurality of projections on a peripheral edge thereof and a plurality of openings into which the grounding and signaling pins pass through. The projections are in pressure contact with an inner surface of the microphone connector and electrically connected to the microphone case. The opening for the grounding pin has projections extending on an inner surface thereof, are in pressure contact with the grounding pin, and are electrically connected to the metal

### BRIEF DESCRIPTION OF THE DRAWINGS

FIG. 1(A) is a cross section of a microphone according to one embodiment of the invention;

FIG. 1(B) is an enlarged cross section of a microphone connector;

FIG. 1(C) is a bottom plan view of the microphone connector;

FIG. 2 is a cross section showing how a shield is fitted in the microphone;

FIG. 3 is a top plan view of the shield;

FIG. 4 is a cross section of the shield; and

FIG. 5(A) and FIG. 5(B) show how to ground the microphone.

### DETAILED DESCRIPTION OF THE INVENTION

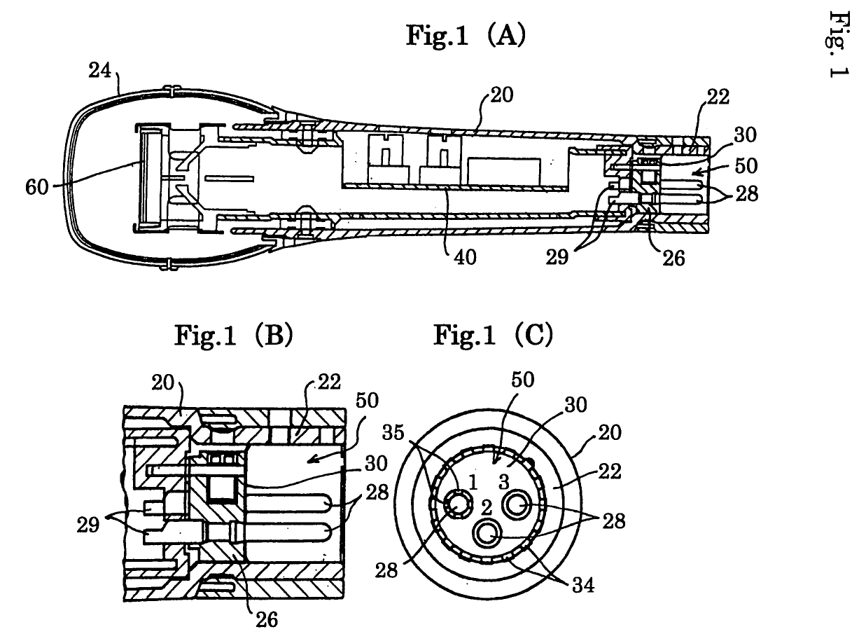

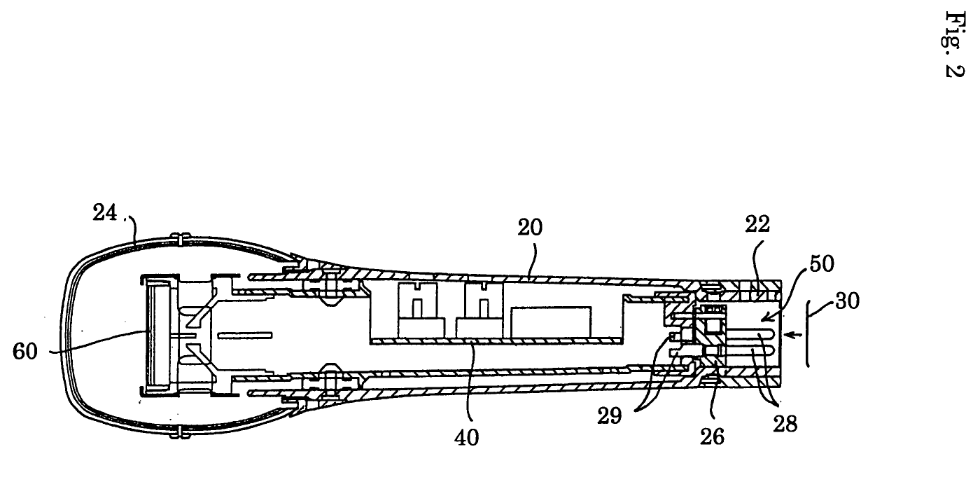

A microphone and a microphone shield will be described with reference to FIG. 1(A), FIG. 1(B), FIG. (C) and FIG. 2. A microphone connector 50 is provided at one end of a microphone case 20. The microphone connector 50 receives a cable connector at one end of a microphone cable, and connects the microphone cable and a microphone circuit. The microphone connector 50 includes a holder 26, and three pins 28 passing through the holder 26. The holder 26 is made of an insulating material and is set back slightly far from an end 22 of the microphone case 20. The three pins 28 are designed in accordance with the EISJ RC-5236 mentioned above. Specifically, No. 1 pin is used for grounding, and No. 2 and No.3 pins are used as hot and cold sides of signal.

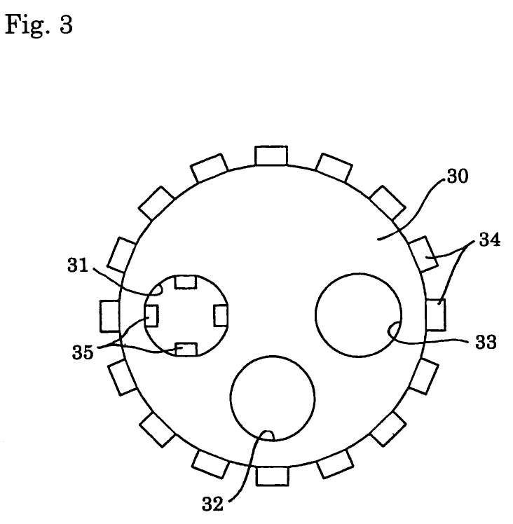

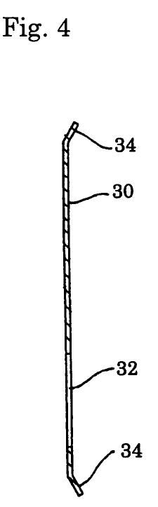

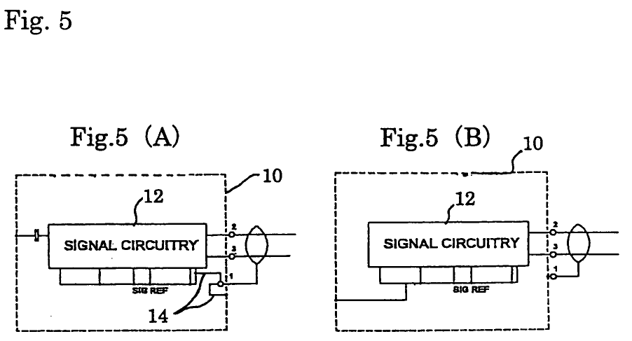

The microphone and the microphone connector of the present invention are characterized in that a metal shield 30 is fitted into the microphone connector 50, as shown in FIG. 3 and FIG. 4. The metal shield 30 is circular, and has openings 31, 32 and 33 thereon and a plurality of equally spaced projections 34 on a peripheral edge thereof. The foregoing three pins 28 pass through the openings 31 to 33, i.e., No. 1 pin passes through the opening 31. Equally spaced projections 35 radially extend from a periphery of the opening 31, and are in pressure contact with No. 1 pin, so that the metal shield 30 is electrically connected to the No. 1 pin. No. 2 pin passes through the opening 32, and No. 3 pin passes through the opening 33. The openings 32 and 33 have diameters larger than those of No. 2 and No. 3 pins. Therefore, there are gaps respectively between the opening 32 and No. 2 pin, and between the opening 33 and No. 3 pin, so that No. 2 and No. 3 pins are not electrically connected to the metal shield 30.

Referring to FIG. 2, the metal shield 30 is elastic to some extent, and is fitted into the microphone case 20 via the end 22 with the projections 34 flexed. At the same time, the projections 35 in the opening 31 are flexibly brought into contact with No. 1 pin, which guides the metal shield 30 into the end 22. The metal shield 30 is positioned to face with an outer surface of the holder 26. When a cable connector at one end of the microphone case 20 is inserted into the microphone connector 50, the pins 28 are fitted into their corresponding metal joints, and are electrically connected to the metal joints. The metal shield 30 faces with the other end of the cable connector.

In the foregoing structure, a shielded conductor of the microphone cable is connected to the metal joint of No. 1 pin, so that the shielded cable, metal shield 30 and microphone case 20 are electrically connected, and are grounded.

As shown in FIG. 1 and FIG. 2, terminals 29 integral with the pins 28 project from the holder 26 in the microphone case 20, and are connected to a wiring pattern of a circuit board 40 provided in the microphone case 20. A capacitor microphone unit 60, is positioned at a front end of the microphone case 20, and has its output signal terminal and a power terminal connected to the wiring pattern of the circuit board 40. A wind shield 24 covers the microphone unit 60.

In this embodiment, the microphone itself is shielded by the microphone case 20, while the microphone connector 50 is protected by the metal shield 30, which blocks high frequency electromagnetic waves arriving via the microphone connector 50. In an environment substantially free from electromagnetic waves from cellular phones, no measures were made to protect the microphone against electromagnetic waves. According to the foregoing embodiment, it is possible to effectively prevent electromagnetic waves from entering into the microphone unit 60 via the microphone connector 50. This is effective in protecting audio signals against noise caused by electromagnetic waves. Especially, the capacitor microphone having a high impedance can be protected against electromagnetic waves and assures a good noise-to-signal ratio.

Further, even when the grounding terminal of the microphone connector and a grounding terminal of the microphone are connected using the conductor in the microphone body, no electromagnetic waves enter into the microphone via the conductor. Therefore, it is possible to prevent not only electric shocks caused by a phantom power for operating the capacitor microphone but also noise mixing into audio signals.

The metal shield 30 is elastic, and the elastic projections 34 on the peripheral edge thereof are in pressure contact with the inner surface of the microphone case 20 (i.e., the inner surface of the microphone connector 50). The projections 35 in the opening 31 are in pressure contact with the grounding pin. Hence, the metal shield 30, the inner surface of the microphone case 20 and the grounding pin are electrically connected, which is effective in shielding the microphone connector 50.

The number of projections 34 on the metal shield 30 may be determined as desired. For example, only one projection 34 can assure the desired effect. Further, the projections 34 may be unequally spaced.

The invention is characterized in fitting the metal shield into the microphone connector, and the structure of the metal shield itself. Therefore, the invention is also applicable to existing microphones when a metal shield is designed in accordance with a specification of the existing microphone.

Although the invention is applicable to any microphone, it is every effective when applied to a capacitor microphone. Further, the invention is applicable to microphones for professional use and general purpose microphones.

What is claimed is:

1. A microphone comprising:
a microphone connector receiving a cable connector provided at one end of a microphone cable, connecting the microphone cable and an inner circuit of the microphone and including grounding and signaling pins;
a microphone case housing the microphone connector; and
a metal shield fitted into the microphone connector, and having at least one projection on a peripheral edge thereof and a plurality of openings into which the grounding and signaling pins pass through, the projections of the metal shield being in pressure contact with an inner surface of the microphone connector and electrically connected to the microphone case, the opening for the grounding pin having projections extending on an inner surface thereof, being in pressure contact with the grounding pin, and being electrically connected to the metal shield.

2. The microphone of claim 1, wherein the metal shield is positioned behind the microphone connector, and faces with one end of the cable connector fitted into the microphone connector.

3. The microphone of claim 1, wherein the opening for the signaling pin has a diameter larger than a diameter of the signaling pin, and there is a clearance between the signaling pin and the opening.

4. The microphone of claim 1, wherein the metal shield is elastic, the projections thereof are in pressure contact with an inner surface of the microphone connector, and the grounding pin is in elastic and pressure contact with the projections in the opening for the grounding pin.

5. A microphone shield for a microphone which comprises a microphone connector receiving a cable connector provided at one end of a microphone cable, connecting the microphone cable and an inner circuit of the microphone and including grounding and signaling pins, and a microphone case housing the microphone connector, the microphone shield comprising a metal shield fitted into the microphone connector, and having a plurality of projections on a peripheral edge thereof and a plurality of openings into which the grounding and signaling pins pass through, the projections being in pressure contact with an inner surface of the microphone connector and electrically connected to the microphone case, and the opening for the grounding pin having projections extending on an inner surface thereof, being in pressure contact with the grounding pin, and being electrically connected to the metal shield.

6. The microphone shield of claim 5, wherein the projections of the metal shield are in pressure and elastic contact with an inner surface of the microphone connector, and the grounding pin is in elastic and pressure contact with the projections in the opening for the grounding pin.

7. The microphone shield of claim 5, wherein the opening for the signaling pin has a diameter larger than a diameter of the signaling pin, and there is a clearance between the signaling pin and the opening.
